(19) United States
(12) Patent Application Publication
(10) Pub. No.: US 2025/0370528 A1
(43) Pub. Date: Dec. 4, 2025

(54) SOUND WAKE-UP DEVICE AND SOUND WAKE-UP METHOD

(71) Applicant: NUVOTON TECHNOLOGY CORPORATION, HSINCHU CITY (TW)

(72) Inventor: Pao-Shu Chang, Zhubei City (TW)

(21) Appl. No.: 18/947,357

(22) Filed: Nov. 14, 2024

(30) Foreign Application Priority Data
May 28, 2024 (TW) 113119703

(51) Int. Cl. G06F 1/3206; G06F 1/3296; H04R 5/04

(52) U.S. Cl. CPC G06F 1/3206; G06F 1/3296; H04R 5/04; H04R 2420/01

(57) ABSTRACT

The preferred embodiment of the present disclosure relates to a sound wake-up device and a sound wake-up method, for waking up a functional circuit. The sound wake-up method includes: converting external sound into a sound electrical signal; sampling the sound electrical signal, and converting the sound electrical signal in a time domain into a sound spectrum signal in a frequency domain; obtaining a high-frequency part of the sound spectrum signal and calculating a high-frequency energy of the high-frequency part; obtaining a mid-frequency part of the sound spectrum signal and calculating a mid-frequency energy of the mid-frequency part; obtaining a low-frequency part of the sound spectrum signal and calculating a low-frequency energy of the low-frequency part; and determining whether to wake up the functional circuit based on respective magnitudes of the high-frequency energy, the mid-frequency energy, and the low-frequency energy.

### CROSS-REFERENCE TO RELATED APPLICATION

This application claims the priority from the TW Patent Application No. 113119703, filed on May 28, 2024, and all contents of such TW Patent Application are comprised in the present disclosure.

### BACKGROUND

### 1. Field of the Invention

The present disclosure is related to technologies to wake up devices from low-power mode, and in particular to a sound wake-up device and a sound wake-up method.

### 2. Description of the Related Art

Sound wake-up technology endows smart devices with the capability of listening to the environment and recognizing specific keywords or voice commands. When a device detects a designated wake-up word, such as “Hey Siri” or “Alexa,” it activates the voice recognition function and prepares to receive subsequent voice commands. However, before activating the costly voice recognition algorithm, the sound wake-up system must first use a lightweight audio processing mechanism to determine whether a possible wake-up word may present. This preliminary mechanism typically continuously monitors the microphone input, searching for audio patterns that match the predetermined wake-up words, such as specific phoneme sequences or energy changes. Once a potential wake-up word is confirmed, the system sends the audio data to the voice recognition engine for further semantic analysis.

Despite the unparalleled convenience provided by the sound wake-up technology, it still faces some inherent drawbacks and challenges. Firstly, even with multi-level sound models, the system may mistakenly recognize unrelated conversations or environmental noise as wake-up words, leading to unnecessary triggers.

### SUMMARY

Embodiments of the present disclosure provide a sound wake-up device and a sound wake-up method to accurately wake up based on sound made by human, thereby facilitating subsequent voice recognition.

Embodiments of the present disclosure provide a sound wake-up device and a sound wake-up method to exclude the influence of background noise, avoid erroneous wake-up, and achieve energy-saving effect.

An embodiment of the present disclosure provides a sound wake-up device for waking up a functional circuit, including: a microphone circuit, a sampling and frequency domain conversion circuit, a high-frequency energy calculation circuit, a mid-frequency energy calculation circuit, a low-frequency energy calculation circuit, an activation determination circuit. The microphone circuit is for receiving external sound and outputting a sound electrical signal. The sampling and frequency domain conversion circuit, coupled to the microphone circuit, is for receiving the sound electrical signal, sampling the sound electrical signal, and converting the sound electrical signal in a time domain into a sound spectrum signal in a frequency domain. The high-frequency energy calculation circuit is for receiving a high-frequency part of the sound spectrum signal and calculating a high-frequency energy of the high-frequency part. The mid-frequency energy calculation circuit is for receiving a mid-frequency part of the sound spectrum signal and calculating a mid-frequency energy of the high-frequency part. The low-frequency energy calculation circuit is for receiving a low-frequency part of the sound spectrum signal and calculating a low-frequency energy of the high-frequency part. The activation determination circuit is for receiving the high-frequency energy, the mid-frequency energy, and the low-frequency energy, and determining whether to wake up the functional circuit based on respective magnitudes of the high-frequency energy, the mid-frequency energy, and the low-frequency energy.

Another embodiment of the present disclosure provides a sound wake-up method for waking up a functional circuit, including: converting external sound into a sound electrical signal; sampling the sound electrical signal, and converting the sound electrical signal in a time domain into a sound spectrum signal in a frequency domain; obtaining a high-frequency part of the sound spectrum signal and calculating a high-frequency energy of the high-frequency part; obtaining a mid-frequency part of the sound spectrum signal and calculating a mid-frequency energy of the mid-frequency part; obtaining a low-frequency part of the sound spectrum signal and calculating a low-frequency energy of the low-frequency part; and determining whether to wake up the functional circuit based on respective magnitudes of the high-frequency energy, the mid-frequency energy, and the low-frequency energy.

According to the sound wake-up device and the sound wake-up method described in the preferred embodiment of the present disclosure, the step of determining whether to wake up the functional circuit based on the respective magnitudes of the high-frequency energy, the mid-frequency energy, and the low-frequency energy includes: waking up the functional circuit when the high-frequency energy is below a first threshold value, the low-frequency energy is below a second threshold value, and the mid-frequency energy is above a third threshold value. In another preferred embodiment, the step of determining whether to wake up the functional circuit based on the respective magnitudes of the high-frequency energy, the mid-frequency energy, and the low-frequency energy includes: storing a previous mid-frequency energy at a previous time; and waking up the functional circuit when the high-frequency energy is below a first threshold value, the low-frequency energy is below a second threshold value, and a difference by which the mid-frequency energy is higher than the previous mid-frequency energy is above a third threshold value.

According to the sound wake-up device and the sound wake-up method described in a preferred embodiment of the present disclosure, the wake-up device further includes: a timing activation circuit, coupled to the microphone circuit, the sampling and frequency domain conversion circuit, the high-frequency energy calculation circuit, the mid-frequency energy calculation circuit, the low-frequency energy calculation circuit, and the activation determination circuit, for activating the microphone circuit, the sampling and frequency domain conversion circuit, the high-frequency energy calculation circuit, the mid-frequency energy calculation circuit, the low-frequency energy calculation circuit, and the activation determination circuit at each predetermined time.

According to the sound wake-up device and the sound wake-up method described in a preferred embodiment of the present disclosure, the sampling and frequency domain conversion circuit includes: an amplifier circuit, an analog-to-digital converter (ADC), and a Fast Fourier Transformer (FFT). The amplifier circuit is for receiving the sound electrical signal and amplifying the sound electrical signal to obtain an amplified sound electrical signal. The analog-to-digital converter is for receiving the amplified sound electrical signal, performing an analog-to-digital conversion, and outputting a digital sound signal. The Fast Fourier Transformer is for receiving the digital sound signal and converting the digital sound signal from the time domain to the frequency domain to obtain the sound spectrum signal.

In summary, a preferred embodiment of the present disclosure calculates the respective energy of the high-frequency part, the mid-frequency part, and the low-frequency part of the sound after sampling the sound electrical signal. During a wake-up determination, in addition to the mid-frequency part of the human sound being large enough to serve as a wake-up condition, the energies of the high-frequency part and low-frequency part are required to be low enough, indicating that the received sound electrical signal is made by a human rather than noise. Thus, the situation where the device is woken up due to noise received by the microphone may be excluded. In another preferred embodiment, in addition to the aforementioned conditions, the mid-frequency energy of the previous time period is also considered. If the mid-frequency energy of the current time period is similar to that of the previous time period, it indicates that someone nearby is chatting, and keeping the device awake would only cause unnecessary power consumption. Thus, the preferred embodiment may also exclude background human sound to avoid erroneous wake-ups.

To further understand the technology, means, and effects of the present disclosure, reference may be made by the detailed description and drawing as follows. In this way, the purposes, features and concepts of the present disclosure can be thoroughly and concretely understood. However, the following detail description and drawings are only used to reference and illustrate the implementation of the present disclosure, and they are not used to limit the present disclosure.

### BRIEF DESCRIPTION OF THE DRAWINGS

The drawings are provided to make the persons with ordinary knowledge in the field of the art further understand the present disclosure, and are incorporated into and constitute a part of the specification of the present disclosure. The drawings illustrate demonstrated embodiments of the present disclosure, and are used to explain the principal of the present disclosure together with the description of the present disclosure.

FIG. 1 is a schematic circuit block diagram of a sound wake-up device according to a preferred embodiment of the present disclosure.

FIG. 2 is a schematic logic operation block diagram of an activation determination circuit 106 of a sound wake-up device according to a preferred embodiment of the present disclosure.

FIG. 3 is a schematic logic operation block diagram of an activation determination circuit 106 of a sound wake-up device according to a preferred embodiment of the present disclosure.

FIG. 4 is a schematic circuit block diagram of a sampling and frequency domain conversion circuit 102 of a sound wake-up device according to another preferred embodiment of the present disclosure.

FIG. 5 is a schematic circuit diagram of a high-frequency energy calculation circuit 103, a mid-frequency energy calculation circuit 104, and a low-frequency energy calculation circuit 105 of a sound wake-up device according to another preferred embodiment of the present disclosure.

FIG. 6 is a schematic block diagram of a sound wake-up device according to a preferred embodiment of the present disclosure.

FIG. 7 is a schematic flowchart diagram of a sound wake-up method according to a preferred embodiment of the present disclosure.

### DESCRIPTION OF THE PREFERRED EMBODIMENTS

The embodiments of the present disclosure are described in detail as reference, and the drawings of the present disclosure are illustrated. In the case of possibility, the element symbols are used in the drawings to refer to the same or similar components. In addition, the embodiment is only one approach of the implementation of the design concept of the present disclosure, and the following multiple embodiments are not intended to limit the present disclosure.

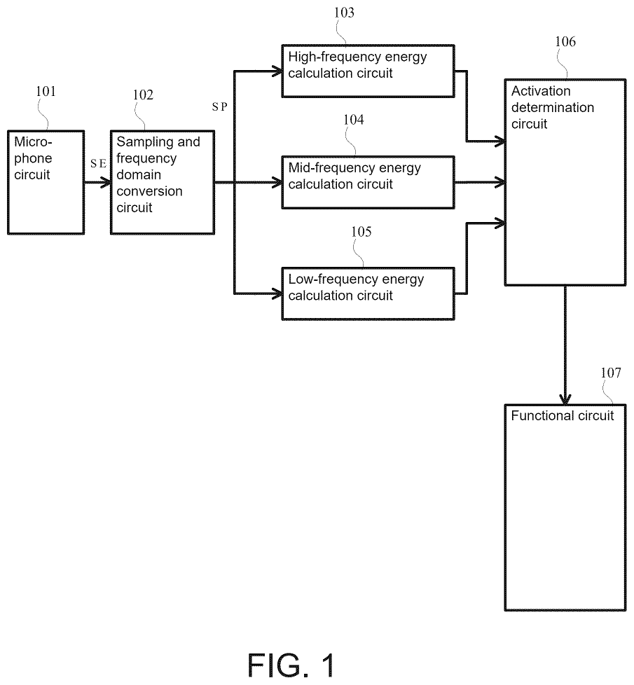

FIG. 1 is a schematic circuit block diagram of a sound wake-up device according to a preferred embodiment of the present disclosure. Please refer to FIG. 1, the sound wake-up device includes a microphone circuit 101, a sampling and frequency domain conversion circuit 102, a high-frequency energy calculation circuit 103, a mid-frequency energy calculation circuit 104, a low-frequency energy calculation circuit 105, and an activation determination circuit 106. For the sake of explanation, a functional circuit 107 is additionally illustrated. The functional circuit 107 is, for example, a voice recognition circuit or another high-power consumption circuit that needs to be activated to operate.

The microphone circuit 101 is for receiving external sound and outputting a sound electrical signal SE. The sampling and frequency domain conversion circuit 102 is coupled to the microphone circuit 101 and is for receiving the sound electrical signal SE, sampling the sound electrical signal SE, and converting the sound electrical signal SE in a time domain into a sound spectrum signal SP in a frequency domain; The high-frequency energy calculation circuit 103 is for receiving a high-frequency part of the sound spectrum signal SP and calculating a high-frequency energy of the high-frequency part. The mid-frequency energy calculation circuit 104 for receiving a mid-frequency part of the sound spectrum signal SP and calculating a mid-frequency energy of the high-frequency part. The low-frequency energy calculation circuit 105 for receiving a low-frequency part of the sound spectrum signal SP and calculating a low-frequency energy of the high-frequency part.

In this embodiment, the sound spectrum signal SP is the sound frequency sampled from 10 Hz to 20 KHz. Since the frequency of voice is the main part to be considered for wake-up. For ordinary people's voices, the fundamental frequency/baseband of the female voice is from 350 Hz to 3 KHz, and the fundamental frequency of the male voice is from 100 Hz to 900 Hz. In this embodiment, the mid-frequency part of the sound spectrum signal SP is sampled from 20 Hz to 4 KHz to cover the fundamental frequency of the sound. Likewise, the part from 10 Hz to 20 Hz is the low-frequency part, and the part from 4 KHz to 20 KHz is the high-frequency part.

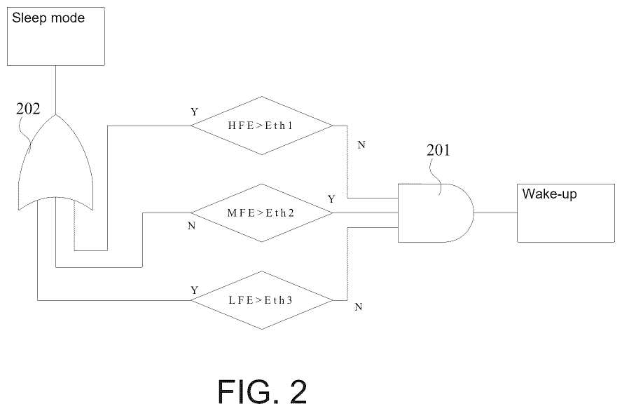

The activation determination circuit 106 is for receiving the high-frequency energy, the mid-frequency energy, and the low-frequency energy, and determining whether to wake up the functional circuit based on respective magnitudes of the high-frequency energy, the mid-frequency energy, and the low-frequency energy. For easier understanding of the activation determination circuit 106, FIG. 2 is served as a representation of its logical operation. FIG. 2 is a schematic logic operation block diagram of an activation determination circuit 106 of a sound wake-up device according to a preferred embodiment of the present disclosure. Please refer to FIG. 2. HFE represents the high-frequency energy calculated by the high-frequency energy calculation circuit 103; MFE represents the mid-frequency energy calculated by the mid-frequency energy calculation circuit 104; and LFE represents the low-frequency energy calculated by the low-frequency energy calculation circuit 105. Eth1, Eth2, and Eth3 are referred to as the first threshold, the second threshold, and the third threshold, respectively.

Based on FIG. 2, it can be seen that three conditions should be simultaneously met for waking up the functional circuit 107: the high-frequency energy (HFE) being lower than the first threshold value (Eth1), the mid-frequency energy (MFE) being higher than the second threshold value (Eth2), and the low-frequency energy (LFE) being lower than the third threshold value (Eth3). Thus, it is represented by a logic AND gate 201 in this figure. In other cases, the wake-up functional circuit 107 must remain in sleep mode. Thus, it is represented by a logic OR gate 202 in this figure. The reason for selecting the high-frequency energy HFE lower than Eth1, the mid-frequency energy MFE higher than Eth2, and the low-frequency energy LFE lower than Eth3 is to ensure that the wake-up is triggered by voice rather than noise. When noise occurs, although it will include an increase in voice frequency energy, the high-frequency energy and low-frequency energy will also increase. In the case of pure voice, the high-frequency energy and the low-frequency energy are relatively small. Thus, in this embodiment, the determination is based on the high-frequency energy HFE being lower than the first threshold value Eth1, the medium-frequency energy MFE being greater than the second threshold value Eth2, and the low-frequency energy LFE being lower than the third threshold value Eth3.

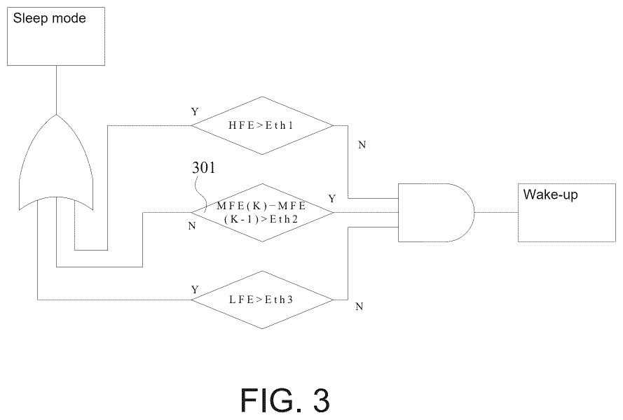

FIG. 3 is a schematic logic operation block diagram of an activation determination circuit 106 of a sound wake-up device according to a preferred embodiment of the present disclosure. Please refer to FIG. 2 and FIG. 3, the main distinction between FIG. 3 and FIG. 2 lies in the difference in the determination formula 301. In this embodiment, MFE(K) represents the currently received mid-frequency energy; MFE(K−1) represents the previously received mid-frequency energy. In this embodiment, in addition to the high-frequency energy HFE being lower than the first threshold value Eth1 and the low-frequency energy LFE being lower than the third threshold value Eth3, the mid-frequency energy MFE(K) must also be higher than the previously received mid-frequency energy MFE(K−1), and the difference between these two mid-frequency energies must be greater than the second threshold value Eth2. It should be noted that the second threshold value Eth2 here and the second threshold value Eth2 in FIG. 2 may be set as different values. The reason is that sometimes people may gather and chat near the device, causing voice to become noisy, but the low-frequency energy or the high-frequency energy are not excessively high at this time. If the functional circuit 107 continues to be woken up without action, it would cause inefficient power consumption. This embodiment may exclude such cases of inefficient power consumption. In the circuit implementation, multiple D-type latch registers may be added to the activation determination circuit 106 to temporarily store and lock the previous mid-frequency energy data.

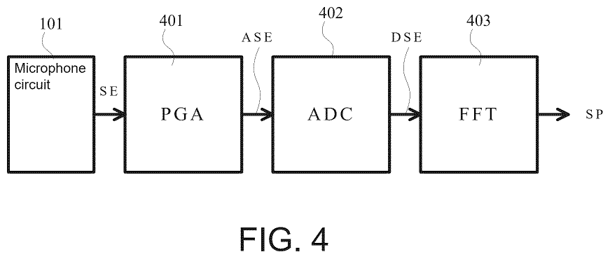

FIG. 4 is a schematic circuit block diagram of a sampling and frequency domain conversion circuit 102 of a sound wake-up device according to another preferred embodiment of the present disclosure. Please refer to FIG. 4, the sampling and frequency domain conversion circuit 102 includes an amplifier circuit 401, an analog-to-digital converter (ADC) 402, and a Fast Fourier Transformer (FFT) 403. The amplifier circuit 401, in this embodiment, is implemented using a Programmable Gate Array (PGA) to receive the sound electrical signal SE and amplify it into an amplified sound electrical signal ASE. Since the microphone circuit 101 can only generate the sound electrical signal SE with a peak-to-peak value (VPP) of 0.1V for the received sound, which is not suitable for, for example, a 3V analog-to-digital converter, the amplifier circuit 401 is required in this embodiment to amplify the signal. The analog-to-digital converter 402 receives the amplified sound electrical signal ASE, performs an analog-to-digital conversion, and outputs a digital sound signal DSE. The Fast Fourier Transformer 403 receives the digital sound signal DSE, converts the digital sound signal DSE from the time domain to the frequency domain, and obtains the sound spectrum signal SP.

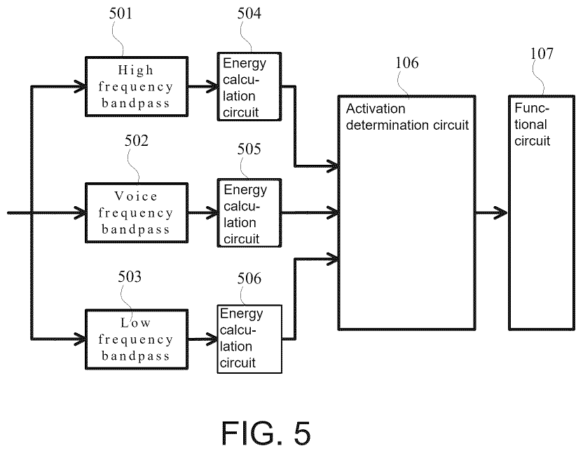

FIG. 5 is a schematic circuit diagram of a high-frequency energy calculation circuit 103, a mid-frequency energy calculation circuit 104, and a low-frequency energy calculation circuit 105 of a sound wake-up device according to another preferred embodiment of the present disclosure. Please refer to FIG. 5, the high-frequency energy calculation circuit 103 is implemented by a digital high-frequency band-pass filter 501 and an energy calculation circuit 504. The mid-frequency energy calculation circuit 104 is implemented by a digital mid-frequency band-pass filter 502 and an energy calculation circuit 505. The low-frequency energy calculation circuit 105 is implemented by a digital low-frequency bandpass filter 503 and an energy calculation circuit 506. As described above, the filtering frequency bands of the digital high-frequency band-pass filter 501, the digital mid-frequency band-pass filter 502, and the digital low-frequency band-pass filter 503 are 10 Hz to 20 Hz, 20 Hz to 4 KHz, and 4 KHz to 20 KHz, respectively. The reason for selecting the digital high-frequency band-pass filter 501, the digital mid-frequency band-pass filter 502, and the digital low-frequency band-pass filter 503 in this embodiment is that digital band-pass filters have obvious advantages in price. Although it is also possible to implement frequency division in analog circuits, besides cost considerations, the size of the device and the need for repeated circuits, such as requiring three sets of analog-to-digital converters, must also be considered.

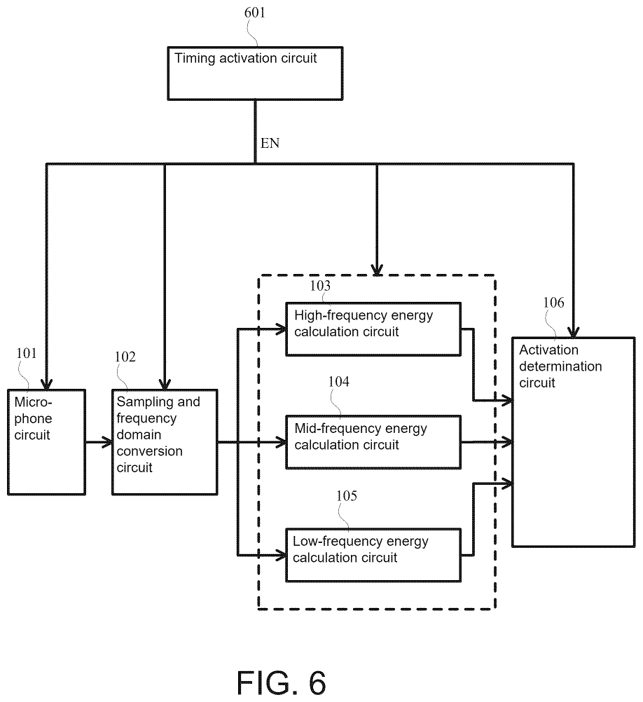

FIG. 6 is a schematic block diagram of a sound wake-up device according to a preferred embodiment of the present disclosure. Please refer to FIG. 1 and FIG. 6. In this embodiment, in addition to all the circuits in original FIG. 1, a timing activation circuit 601 is added. The timing activation circuit 601 is coupled to the microphone circuit 101, the sampling and frequency domain conversion circuit 102, the high-frequency energy calculation circuit 103, the mid-frequency energy calculation circuit 104, the low-frequency energy calculation circuit 105, and the activation determination circuit 106. The timing activation circuit 601 is mainly for activating the microphone circuit 101, the sampling and frequency domain conversion circuit 102, the high-frequency energy calculation circuit 103, the mid-frequency energy calculation circuit 104, the low-frequency energy calculation circuit 105, and the activation determination circuit 106 at each predetermined time. The main implementation method may be, for example, pulse width modulated an enabling signal EN, so that the enabling signal EN is enabled for a first period and disabled for a second time period. In this way, it may achieve a more energy-saving effect.

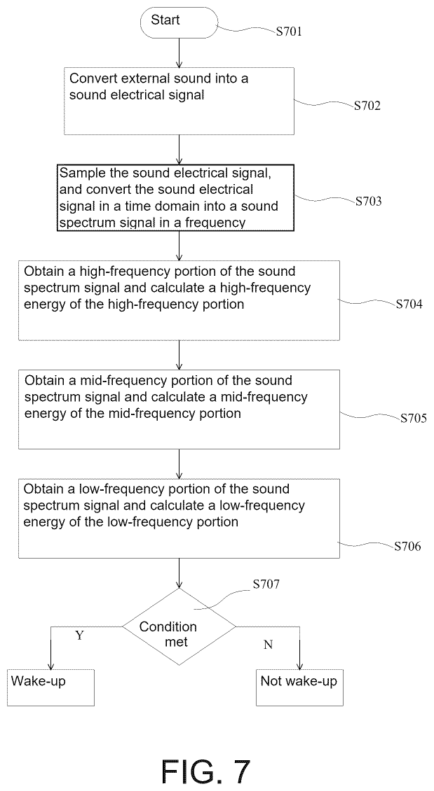

According to the aforementioned embodiments, a sound wake-up method may be summarized. FIG. 7 is a schematic flowchart diagram of a sound wake-up method according to a preferred embodiment of the present disclosure. Please refer to FIG. 7, the sound wake-up method includes the following steps:
Step S701: Start.
Step S702: Convert external sound into a sound electrical signal, such as through the microphone circuit 101.
Step S703: Sample the sound electrical signal and convert the sound electrical signal in a time domain into a sound spectrum signal in a frequency domain.
Step S704: Obtain a high-frequency part of the sound spectrum signal and calculate a high-frequency energy of the high-frequency part.
Step S705: Obtain a mid-frequency part of the sound spectrum signal and calculate a mid-frequency energy of the mid-frequency part.
Step S706: Obtain a low-frequency part of the sound spectrum signal and calculate a low-frequency energy of the low-frequency part.
Step S707: Determine whether to wake up the functional circuit based on respective magnitudes of the high-frequency energy, the mid-frequency energy, and the low-frequency energy. As described in the embodiment of FIG. 2, the criterion where the mid-frequency energy is high, and the high-frequency energy and the low-frequency energy are low is used for wake-up. Likewise, in scenarios involving a large number of people, the criterion where the high-frequency energy and the low-frequency energy are low, and the mid-frequency energy is higher than the previous mid-frequency energy may be used for wake-up, as described in the embodiment of FIG. 3.

As described above, a preferred embodiment of the present disclosure calculates the respective energy of the high-frequency part, the mid-frequency part, and the low-frequency part of the sound after sampling the sound electrical signal. During a wake-up determination, in addition to the mid-frequency part of the human sound being large enough to serve as a wake-up condition, the energies of the high-frequency part and low-frequency part are required to be low enough, indicating that the received sound electrical signal is made by a human rather than noise. Thus, the situation where the device is woken up due to noise received by the microphone may be excluded. In another preferred embodiment, in addition to the aforementioned conditions, the mid-frequency energy of the previous time period is also considered. If the mid-frequency energy of the current time period is similar to that of the previous time period, it indicates that someone nearby is chatting, and keeping the device awake would only cause unnecessary power consumption. Thus, the preferred embodiment may also exclude background human sound to avoid erroneous wake-ups.

It should be understood that the examples and the embodiments described herein are for illustrative purpose only, and various modifications or changes in view of them will be suggested to those skilled in the art, and will be comprised in the spirit and scope of the application and the appendix with the scope of the claims.

What is claimed is:

1. A sound wake-up device for waking up a functional circuit, comprising:
a microphone circuit for receiving external sound and outputting a sound electrical signal;
a sampling and frequency domain conversion circuit, coupled to the microphone circuit, for receiving the sound electrical signal, sampling the sound electrical signal, and converting the sound electrical signal in a time domain into a sound spectrum signal in a frequency domain;
a high-frequency energy calculation circuit for receiving a high-frequency part of the sound spectrum signal and calculating a high-frequency energy of the high-frequency part;
a mid-frequency energy calculation circuit for receiving a mid-frequency part of the sound spectrum signal and calculating a mid-frequency energy of the high-frequency part;
a low-frequency energy calculation circuit for receiving a low-frequency part of the sound spectrum signal and calculating a low-frequency energy of the high-frequency part; and
an activation determination circuit for receiving the high-frequency energy, the mid-frequency energy, and the low-frequency energy, and determining whether to wake up the functional circuit based on respective magnitudes of the high-frequency energy, the mid-frequency energy, and the low-frequency energy.

2. The sound wake-up device according to claim 1, wherein the activation determination circuit wakes up the functional circuit when the high-frequency energy is below a first threshold value, the low-frequency energy is below a second threshold value, and the mid-frequency energy is above a third threshold value.

3. The sound wake-up device according to claim 1, wherein the activation determination circuit further comprises storing a previous mid-frequency energy at a previous time, and wherein the activation determination circuit wakes up the functional circuit when the high-frequency energy is below a first threshold value, the low-frequency energy is below a second threshold value, and a difference by which the mid-frequency energy is higher than the previous mid-frequency energy is above a third threshold value.

4. The sound wake-up device according to claim 1, wherein the sampling and frequency domain conversion circuit comprises:
an amplifier circuit for receiving the sound electrical signal and amplifying the sound electrical signal to obtain an amplified sound electrical signal;
an analog-to-digital converter (ADC) for receiving the amplified sound electrical signal, performing an analog-to-digital conversion, and outputting a digital sound signal; and
a Fast Fourier Transformer (FFT) for receiving the digital sound signal and converting the digital sound signal from the time domain to the frequency domain to obtain the sound spectrum signal.

5. The sound wake-up device according to claim 1, wherein the high-frequency energy calculation circuit comprises:
a digital high-frequency band-pass filter for receiving the sound spectrum signal and obtaining the high-frequency part of the sound spectrum signal; and
an energy calculation circuit, coupled to the digital high-frequency band-pass filter, for receiving the high-frequency part and converting the high-frequency part into the high-frequency energy.

6. The sound wake-up device according to claim 1, wherein the mid-frequency energy calculation circuit comprises:
a digital mid-frequency band-pass filter for receiving the sound spectrum signal and obtaining the mid-frequency part of the sound spectrum signal; and
an energy calculation circuit, coupled to the digital mid-frequency band-pass filter, for receiving the mid-frequency part and converting the mid-frequency part into the mid-frequency energy.

7. The sound wake-up device according to claim 1, further comprising:
a timing activation circuit, coupled to the microphone circuit, the sampling and frequency domain conversion circuit, the high-frequency energy calculation circuit, the mid-frequency energy calculation circuit, the low-frequency energy calculation circuit, and the activation determination circuit, for activating the microphone circuit, the sampling and frequency domain conversion circuit, the high-frequency energy calculation circuit, the mid-frequency energy calculation circuit, the low-frequency energy calculation circuit, and the activation determination circuit at each predetermined time.

8. A sound wake-up method for waking up a functional circuit, comprising:
converting external sound into a sound electrical signal;
sampling the sound electrical signal, and converting the sound electrical signal in a time domain into a sound spectrum signal in a frequency domain;
obtaining a high-frequency part of the sound spectrum signal and calculating a high-frequency energy of the high-frequency part;
obtaining a mid-frequency part of the sound spectrum signal and calculating a mid-frequency energy of the mid-frequency part;
obtaining a low-frequency part of the sound spectrum signal and calculating a low-frequency energy of the low-frequency part; and
determining whether to wake up the functional circuit based on respective magnitudes of the high-frequency energy, the mid-frequency energy, and the low-frequency energy.

9. The sound wake-up method according to claim 8, wherein the step of determining whether to wake up the functional circuit based on respective magnitudes of the high-frequency energy, the mid-frequency energy, and the low-frequency energy comprises:
waking up the functional circuit when the high-frequency energy is below a first threshold value, the low-frequency energy is below a second threshold value, and the mid-frequency energy is above a third threshold value.

10. The sound wake-up method according to claim 8, wherein the step of determining whether to wake up the functional circuit based on respective magnitudes of the high-frequency energy, the mid-frequency energy, and the low-frequency energy comprises:
storing a previous mid-frequency energy at a previous time; and
waking up the functional circuit when the high-frequency energy is below a first threshold value, the low-frequency energy is below a second threshold value, and a difference by which the mid-frequency energy is higher than the previous mid-frequency energy is above a third threshold value.
